(19) United States
(12) Patent Application Publication
(10) Pub. No.: US 2012/0296812 A1
(43) Pub. Date: Nov. 22, 2012

(54) SYSTEMS AND PROCESSES FOR PROVIDING PERFORMANCE CONTENT ON A COMMUNICATION NETWORK

(76) Inventors: Gregory A. Piccionelli, Westlake Village, CA (US); Ted R. Rittmaster, Westlake Village, CA (US)

(21) Appl. No.: 13/473,221

(22) Filed: May 16, 2012

Related U.S. Application Data
(60) Provisional application No. 61/519,064, filed on May 16, 2011.

(51) Int. Cl. G06F 15/16; A63F 9/20; A63F 9/24; G06Q 40/00; G06F 17/00

(52) U.S. Cl. 705/39; 709/204; 463/42; 463/16; 463/14; 463/10; 463/13; 463/11; 463/12; 463/9

(57) ABSTRACT

A system and process for operating a computer on a communication network involves providing a first performance environment, such as a first game, over the network to a first on-line user, receiving performance data from the first on-line user corresponding to the first on-line user's performance in the first performance environment. A value is defined for performance rights associated with the received data. A second performance environment that is separate from the first performance environment is provided over the network to a second on-line user, in which the second on-line user is able to make a performance. The second on-line user is provided with access to received data corresponding to the first on-line user's performance in the first performance environment, while the second on-line user is making a performance in the second performance environment.

This application claims priority from U.S. Provisional Application No. 60/519,064 filed May 16, 2011 for SYSTEMS AND PROCESSES FOR PROVIDING PERFORMANCE CONTENT ON A COMMUNICATION NETWORK.

### BACKGROUND OF THE DISCLOSURE

1. Field Of The Invention

The present application relates to systems and processes for providing performance content on a communication network and, in particular embodiments for providing game or other performances on a communication network and compensating performers for content or other performance rights.

2. Related Art

Distribution of content on electronic communications networks, such as the Internet, has become an important aspect of many business and social interactions. Performers post recorded performances on websites, user-generated content services such as YouTube, social sites such as Facebook and the like. In most cases, performers are not compensated for their performances, even if their performances have significant artistic or creative merit and/or the performer exhibits a high level of skill in the performance.

Performances are distributed on a communication network in the form of audio, visual or even tactile information communicated, electronically, and displayed to a user on traditional (or non-traditional) user interface devices, such as display screens, audio speakers, vibration or other haptic or tactile output device, or the like. Performances may be in any suitable form, including, but not limited to, musical, acting, sports, game, or educational performances, or the like.

Performances can include performance on an electronic game, such as, but not limited to, electronic video game, electronic gambling game, a virtual world game or the like. Internet gambling, including online poker, is a large generator of online revenue, worldwide. Many countries, however, including the United States, have severely limited online gambling operators' ability to provide the necessary financial transactions to effectuate online gambling or have prohibited online gambling altogether. However, many of those countries that prohibit financial transactions in gaming (such as on-line poker games) do allow for performers to be compensated for viewing rights or other intellectual property rights in their performances.

### SUMMARY

Accordingly, embodiments of the present invention are configured to provide a mechanism for distributing performance content on a communication network and, in particular embodiments, for compensating performers for viewing rights or other intellectual property rights in their performances. In certain embodiments, a performer may participate in an online game, such as a poker game, while being compensated for licensing or assigning the viewing or other publication rights, the derivative works rights, the right to use the performer's name and/or likeness and other rights associated with the performer's performance. Particular embodiments are configured to provide a mechanism by which a network user may participate in an online game (such as, but not limited to a poker game or other game involving betting or wagering and one or more player performances during the game), in jurisdictions in which online gambling is prohibited, and, in some contexts, be compensated for viewing rights or other intellectual property rights in the user's performance in the game. In further embodiments, other network users or third party players (who may be in jurisdictions that allow gambling) may participate in a corresponding copy or mirror version of the game (or in other games that employ the performer's performance actions), by purchasing or otherwise obtaining rights to view or use the performer's performance as (or to determine) the other network user's performance in the copy or mirror version of the game.

In an some example embodiments, online players in a country or geographic region in which online gambling is prohibited, engage in a lawful performance (such as, but not limited to, a performance as a player in a game of online poker provided by an online game provider service, where an online poker game is described herein as a conveniently explained, but non-limiting example performance environment). In particular embodiments the players purchase a virtual gambling sum from the provider service (such as, but not limited to tokens, virtual poker chips, or other forms of virtual value which, in certain embodiments, cannot be redeemed or returned for a refund). The virtual gambling sum is used as wagers or bets during the game and can increase or decrease, based on the success of the player's performance, during the game. In embodiments in which the virtual gambling sum is not redeemable or returnable for money or items of value, the game is played “for fun only” by the performers (“For-Fun Players”).

The provider service for the game enters into an agreement (for example, an agreement provided online, through a website or other online source) with the performers (For-Fun Players) to license the intellectual property rights of the performer's performance (an original performance) in the performance event (for example, an online poker game) for contemporaneous and/or later use. The original performance is recorded and/or simultaneously transmitted by the provider as the source content (for example, source poker play content) for use or exploitation in one or more other performances simultaneously performed or to be performed by third party performers or players (for example, in other online poker games, such as, but not limited to, copied or mirrored versions of the original performance). From the perspective of the third party player, the live or recorded play of the performers (For-Fun Players) can be analogous to the poker play hands and subsequent actions generated by an automated, online poker program or slot machine, except that the play content is at least partially generated in the instant case on computers operated by real persons (performers) based on cards dealt to those persons (performers), rather than a solely a computer program.

In some embodiments, the performance involves the use of videoconferencing or “live chat” technology, such as, but not limited to they type provided by iMeet™. In such embodiments, the content provided includes electronically generated video, audio, tactile or haptic likenesses and characteristics of the players. In some embodiments, the live or recorded performance is provided as performance entertainment to third party audiences. In some embodiments, the live or recorded performance is used as the gaming content for third party performers (players) who play against one another through the moves, plays or other performance actions made by the original performers (For-Fun Players) and/or through the game happenings (such as cards dealt, other game events determined without player input). In example embodiments, each third-party performer player has chosen or has been assigned a performer (For-Fun Player) who's play is adopted by the third party performer player (to exactly or partially replicate in a copy or mirror performance event). In some embodiments, the third party performer players are in jurisdictions in which online gambling is permitted. In such instances, the third parties can bet against one another with real money wagers. In some instances the third-parties play comprises the exact play of their For-Fun Player doppelgangers. In other instances, the third-party players can deviate from the For-Fun Player's performance, in some instances for a fee. In some other embodiments a third party performer player can play side hands against their own designated performer (For-Fun Player) “champion”, for fun or for real money in jurisdictions where such online wagering is legal.

In some embodiments, the provider service also provides the performers (For-Fun Players) an option to license the rights to their live performance and/or fixations of their performance of their online for-fun poker play (“Copyrights”or other rights associated with the performance). In some embodiments the license is provided by the performers (For-Fun Players) for the use of their respective names, likenesses, voices and/or characteristics (“Rights of Publicity”). In some embodiments the performers (For-Fun Players) are compensated for the licensing of a combination of their Copyrights and Rights of Publicity.

In some embodiments, where the provider server and/or a third party performer player or other online entity (“other Contributor”) provides a human or avatar dealer, pit boss or other participant in the game, the Other Contributor(s) may also be compensated for the Other Contributor's rights. In some embodiments, the Other Contributor(s) can be charged a fee to participate in a performance event (or fees for pre-defined or each stage or action carried out in participating in a performance event).

In some embodiments, the amount of the license to the For-Fun Players is determined at specified stages (or actions occurring) during the performance, such as, but not limited to, at each hand, deal or card revealed during a poker game performance event (e.g., on the basis of each new hand, deal, or card, provided or revealed to the For-Fun Player).

In some embodiments the amount of the license can be determined or scaled to approximate the For-Fun Player's chances of beating the other For-Fun Player(s) (or the service provider computer), for example, continuously, or at pre-defined stages or at each stage in the performance process (for example, but not limited to each hand, deal or card revealed in a poker game performance event). For example, if two For-Fun Players play a game of poker comprising (1) an initial deal, (2) a betting round, (3) a second deal and (4) a final betting round, license fees could be automatically generated and paid to each of the For-Fun Players for each of the stages in the hand (1 through 4). In some embodiments, the For-Fun Players could electronically agree, for example, during a registration process at the commencement of their session, to be paid license fees in amounts that approximately correspond to the probabilistic outcomes for each hand and/or from the perspective of each stage in the hand. In some embodiments, the license payments could account for the probabilities involving more than one deck, or other parameters that effect probability of winning by one or more players performing in the performance event.

In some preferred embodiments a separate license is entered into by the For-Fun Player and the provider at the time each new performance stage or move (such as game move) is made through an electronic acceptance message (“I accept”) or any other recognized mechanism of enforceable online acceptance. Providing and entering into a large number individual intellectual property license agreements, and accounting of amounts due the contracting parties, whether by session, hand, deal, card, other performance action or happening or by performance event can be accomplished using digital or electronic signatures, and modern accounting and/or database software.

In some preferred embodiments the provider service can generate profits comprising the difference between revenues collected from the sale of the non-redeemable virtual chips to For-Fun Players (and/or Other Contributors) and the payment of the intellectual property licensing fees to the For Fun Players (and/or Other Contributors). In other embodiments, the provider can generate additional revenues and profits from the exploitation of the live and recorded play of the For-Fun Players as well as from the “house share” charged against real gambling by third-party players using the For-Fun Play content or from betting on one or more of the For-Fun-Players.

In example embodiments described herein, a performance event in the form of a poker game (such as a computer-generated poker game with video and/or audio-video user interfacing, that can be played online over a communication network, such as the Internet) is described. However, other embodiments of the invention are configured to provide other types of performance events, including other types of game performance events such as, but not limited to online blackjack, pai gow, baccarat, bridge and other card games, craps, ma Jong, dominos, chess, backgammons well as for other games, including online video games, or events that can involve wagering or gambling and for which there is a creative input of the players sufficient to generate a cognizable intellectual property right. Thus, for example, live video and recorded video of game play of a number of participants playing craps, where the players and/or dealers engage in creative and/or colorful language and actions while playing the game, may make for interesting intellectual property.

### BRIEF DESCRIPTION OF DRAWINGS

A brief description of preferred embodiments of the invention will be made with reference to the accompanying drawings, wherein:

FIG. 1 is a generalized block diagram of a system on a communication network, according to an embodiment of the present invention.

FIG. 2 is a generalized flow chart of a process and system operation according to an embodiment of the present invention.

FIG. 3 is a generalized flow chart of a process and system operation according to a further embodiment of the present invention.

### DETAILED DESCRIPTION

The following detailed description is of the best presently contemplated mode of carrying out the invention. This description is not to be taken in a limiting sense, but is made merely for the purpose of illustrating the general principles of the invention. The scope of the invention is best defined by the appended claims.

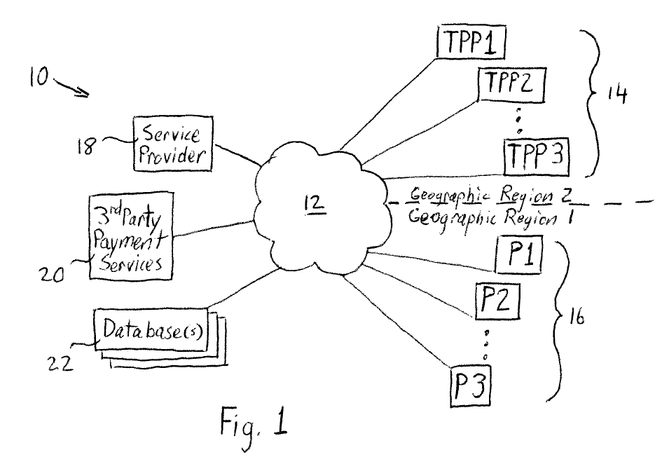

FIG. 1 is a generalized block diagram, showing an example of a system 10 for communication of performance content over an electronic communication network 12, such as, but not limited to, the Internet. A system 10 according to embodiments of the present invention includes all of the components shown in FIG. 1 and described herein. In further embodiments, the system 10 includes some, but not all of the components described with respect to FIG. 1.

Embodiments of the system 10 are configured to provide a format in which one or more performers may participate in a performance event. In particular embodiments, the performance event includes an electronically generated environment, such as, but not limited to, an electronic video game environment; an electronic exercise or sports game, training or demonstration environment; an electronic musical game, training or demonstration environment; a theatrical game, training or demonstration environment; other electronic game, training or demonstration environments; or the like. The performance environment may be provided by one or more programmable processors (such as, but not limited to a server computer or one or more performer computers, as described below), programmed or otherwise configured to provide electronic information for operating the electronically generated environment. In particular embodiments, one or more performers (users) are each on a computer connected for communication on the communication network 12 for communication with one or more server computers and/or one or more other performer and/or third party performer (user) computers.

For example, in embodiments in which the environment is an electronic video game, such as video poker, one or more programmable processors are programmed to provide a poker game environment (including, but not limited to, display of cards on a user computer, dealing cards, drawing cards, taking or recording bets, or the like), where one or more users on associated electronic, programmable computers are each able to play as a card-playing performer in the game. Electronic poker games (and other electronic games) that are configured to allow one player (or multiple, simultaneous players) to play on a computer, against one or more other players on computers or against a programmed computer (such as a server computer or the user's computer running a game program) are well known. Embodiments of the present invention employ game environments (or other performance event environments) that are configured to allow one or more performers play against each other or against a computer, but further provide performers an ability to offer, license or sell performance rights in that performers performance in the game, and/or allow third party performers to play a copy or mirror of the performance event and perform as one of the players in the copy or mirror performance event.

The system 10 in FIG. 1 includes at least one Performer 14, shown in FIG. 1 as P1, P2 . . . PN (to indicate that the number of Performers 14 may be any number from 1-N, where N represents any number up to the maximum number of Performers that the game, sport, or other event being performed and the technical system as able to support). The system 10 also includes at least one Third Party Performer 16, shown in FIG. 1 as TPP1, TPP2 . . . TPPN (to indicate that the number of Third Party Performers 16 may be any number from 1-N, where N represents any number up to the maximum number of Third Party Performers that the game, sport, or other event being performed and the technical system as able to support).

Each Performer 14 and Third Party Performer 16 comprises a computer coupled for communication on the network 12 and programmed, configured and operated to perform functions as described herein, for a computer user to perform (as a performer or third party performer) in a performance event. A Performer 14 and Third Party Performer 16 computer may comprise any suitable electronic, programmable computing device having network communication capabilities, such as, but not limited to, a desk top computer, a portable computer, a laptop, personal digital assistant, mobile telephone, pad computer, or the like. The Performer 14 and Third Party Performer 16 computer includes one or more display devices for providing the user with visual, audio, tactile output, or any combinations thereof Such display devices may include, but are not limited to, video display screens, audio speaker systems, motion producing devices, or the like. The Performer 14 and Third Party Performer 16 computer includes one or more input devices for allowing a user to input information, such as, but not limited to, textual, video, audio, motion and/or other information. Such input devices may include, but are not limited to, keyboards, electronic writing pads and/or pens, touch screens, joy sticks, knobs, buttons or other user-operable devices that produce electronic signals representing a user's input.

The system 10 in FIG. 1 further includes a Service Provider Entity SPE 18, which comprises one or more server computers coupled for communication on the network 12, and programmed, configured and operated to perform functions as described herein. In further embodiments, the system 10 includes one or more Third Party Payment Services TPPS 20, and/or one or more network accessible Databases 22. Each of the TPPS 20 and Databases 22 comprises one or more computers coupled for communication on the network 12 and programmed, configured and operated to perform functions as described herein.

The SPE 18 is configured to provide one or more performance environments to the Performers 14 and Third Party Performers 16 over the network 12. In example embodiments described herein, the SPE 18 provides a Third Party Performer 16 a mirror (or copy) of the original performance environment provided to an associated Performer 14. The SPE 18 also provides the Third Party Performer 16 with information indicating the performance actions, moves or environmental happenings made by or provided to his or her associated Performer 14 in the performance event. In this manner, the mirror or copy performance includes (or, in some embodiments, can include, at the Third Party Performer's discretion), the same performance actions, moves and/or environmental happenings as occurring (or as had occurred) in the original performance.

In some embodiments, the SPE 18 provides or associates the Third Party Performer 16 with actions, moves or environmental happenings in the mirror (or copy) performance, corresponding to (or identical to) the performance actions, moves or environmental happenings of the associated Performer 14 in the performance event. For example, if the performance event is a poker game, the same cards are dealt to the Third Party Performer 16 in the mirror (or copy) performance of the poker game as the cards dealt to the Performer 14 in the poker game performance event. Similarly, the same cards are played (or discarded and drawn) to the Third Party Performer 16 in the mirror (or copy) performance of the game as played (or discarded and drawn) by the Performer 14 during rounds or stages of the poker game performance event. In other embodiments, the SPE 18 allows the Third Party Performer 16 to select those same actions, moves or happenings or, instead alter those actions, moves or happenings for the Third Party Performer's performance in the mirror (or copy) performance event. In some embodiments, the SPE 18 provides or associates a plurality of Third Party Performers with actions, moves or environmental happenings in the mirror (or copy) performance.

A performance environment may be, for example, data for displaying a computer game, video game, video sports activity, or other performance environment, in which a user on a computer (Performers 14 and Third Party Performers 16) may participate, for example, by providing input that alters the outcome of the game or other performance. For example, a performance environment may relate to an electronic game, such as, but not limited to poker, blackjack, pai gow, baccarat, and other card games, craps, ma Jong, chess, checkers, backgammon, dominos, as well as for other games, including online video games, or events that can involve wagering or gambling and for which there is a creative input of the players sufficient to generate a cognizable intellectual property right. In other embodiments, a performance may also be the playing of a part in a musical composition or other artistic performance, including, without limitation, a performance that is effectuated by hand or body movements captured by gesture capture technologies such as Microsoft's Natal technology.

A performance environment may relate to a video game or a massively multiplayer online game, such as, but not limited to, World Of Warcraft. A performance environment may relate to a computer sports games, such as, but not limited to computer game versions of football, baseball, basketball, soccer, hockey, tennis, bowling, shuffleboard, human, horse, dog, automobile or boat racing, Olympic competition sports, and the like. A performance environment may relate to an exercise, physical skill, artistic skill, or physical tolerance activity, such as, but not limited to, yoga, dancing, martial arts, gymnastics, ballet, ice skating, diving, playing of a musical instrument, and the like. A performance environment may relate to combinations of such games, sports or other activities or tournaments of one or more of such games, sports or activities.

The SPE 18 provides some or all of the software and data to the Performers 14 and Third Party Performers 16, for displaying images, allowing user input and altering images based on user input, via computers associated with the Performers 14 and Third Party Performers 16. Such software and data may be provided by electronic transmission over the network 12, for example, in conjunction with performer registration procedures and/or during the performance of a performance event, as described below. Alternatively, or in addition, such software and data may be provided to Performers 14 and/or Third Party Performers 16 through other suitable mechanisms for transmission and receipt of electronic information, including, but not limited to the conveyance of a non-transient computer medium by postal mail, hand, or otherwise.

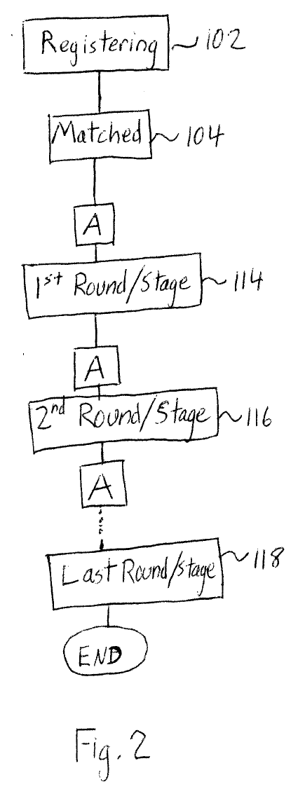

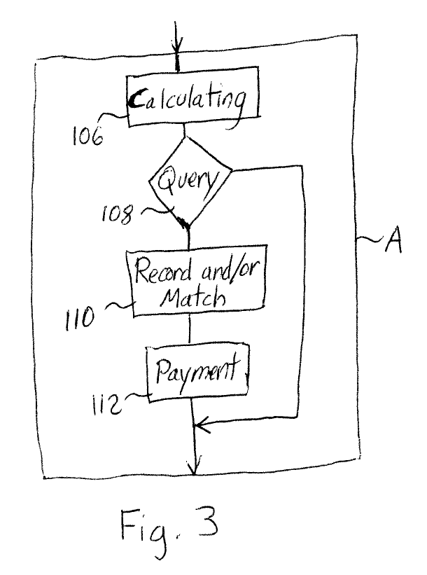

FIGS. 2 and 3 show an example of a process flow for a process according to an embodiment of the present invention. The order of items in the process may be different than that shown in FIGS. 2 and 3, where such order is not required to carry out the overall process.

In general, an example process 100 as represented in FIG. 2 includes Registering 102 a Performer 14 (such as P1) for a performance event with the SPE 18. Once registered (or before or as part of the registration process), P1 is Matched 104 with one or more other players, such as P2 . . . PN, as one or more teammates, opponents, and/or other players for the performance event. In FIG. 2, the process 100 proceeds with steps shown in FIG. 3, including Calculating 106 performance right price values for P1 and, in further embodiments, for one or more of P2 . . . PN.

As part of Calculating 106, a calculated performance right price value (PRPV) is associated with the performer P1 (or with each performer P1-PN for which a PRPV is calculated). Each performer may have a different associated PRPV as compared to the other performer(s). Alternatively, the same or similar PRPVs may be associated with different performers. Various manners of calculating PRPVs according to embodiments of the present invention are described below.

The procedure in FIG. 3 further involves a Query 108 to the Performer Pl, asking whether or not that performer would like to offer, license or sell performance rights in that performer's (P 1′s) performance in the event. The Performer P1 (or any one or more of Pl-PN) submits to the SPE (and the SPE receives from one or more of P1-PN) a response to the Query 108, where the response includes information indicating either that P1 (or any one or more of P1-PN) desires or does not desire to offer, license or sell the performance rights. In further embodiments, the response may include additional information, such as, but not limited to information identifying specific rights or specific portions of the performance being offered.

If the Performer P1 desires to offer, license or sell that performer's performance rights in the event, then P1 responds to the Query 108 with a positive response, as indicated by the Y branch from Query 108. For the Performer P1 (or any one or more of P1-PN) that provided a positive response to the Query 108, the SPE performs a Record and/or Match step 110. In step 110, the SPE electronically records the performer's performance during the event. The SPE may seek to offer, license or sell the recorded performance rights in subsequent transactions. Alternatively, or in addition, the SPE matches and associates one or more TPP with each Performer P1 (or any one or more of Pl-PN). The SPE may collect a payment from each TPP, as described below. In certain embodiments, a TPP is a third party player who desires to purchase rights, such as, but not limited to viewing, copying or other rights associated with the performance by the Performer P1 (or any one or more of P1-PN) in the performance event.

The procedure in FIG. 3 further involves Payment 112, where the SPE collects a payment from each TPP that has been associated with a performer. Alternatively, or in addition, the SPE pays the Performer P1 (or any one or more of P1-PN) a performance fee. In particular, the Performer P1 (or any one or more of P1-PN) that provided a positive response to the Query 108 is paid a performance rights fee, based on the PRPV associated with that performer. Various manners of carrying out Payment according to embodiments of the present invention are described below.

The process returns to FIG. 2, a first round or stage of the performance event is performed. The performance event may include an activity performable on a computer, such as, but not limited to a computer game, video game, computer-human interactive program, an educational event, an entertainment event, or other event that involves user input and output by a performer. In particular embodiments, the SPE provides a set of computer readable instructions that can be carried out by the computers of P1-PN and TPP1-TPPN for playing the performance event. The game or other event can have multiple rounds or stages (such as rounds or periods of play in a game). In FIG. 2, a First Round or Stage of the performance event is carried out at 114.

The process of FIG. 2 returns to the procedure of FIG. 3, after the First Round or Stage 114 of the performance event. Then the process returns again to FIG. 2, for a Second Round or Stage 116 of the performance event. After the Second Round or Stage 116, the process returns to FIG. 3 and the routine continues until the completion of the Last Round or Stage 118 of the performance event. The process of FIG. 2 ends after completion of the Last Round or Stage 118 of the performance event. However, in further embodiments, additional procedures may be carried out following the Last Round or Stage 118 of the performance event. While FIGS. 2 and 3 show an example in which a performance event includes more than two Rounds or Stages, other embodiments employ performance events with any suitable number of Rounds or Stages, including no more than one or no more than two Rounds or Stages.

In accordance with a process as described with respect to FIGS. 2 and 3, a Performer P1 (or any one or more Performers P1-PN) may offer, license or sell performance rights to their performance in a performance event. In some embodiments, the offer to license or sell performances rights may be effectuated by an online bidding or auction process.

In addition, Third Party Players TTP1-TTPN may participate by, for example, by receiving the same performance event instructions from the SPE, so that the TTPs can play a mirror version (a virtual copy) of the same performance event being played by (or that was played by) the associated Performers P1-PN. Each TTP may make the same performance (during the mirror performance event) as its associated Performer P1-PN made in the performance event and, in that manner, each TTP may participate as a performer in a mirror performance and may mirror (or copy) each move or action of its associated Performer Pl-PN during the performance. In further embodiments, each TTP may modify or decide not to copy the associated Performer's P1-PN's move or action at any particular part of the mirror performance event.

Each TTP may play with, against or opposite to one or more other TTPs who are associated with Performers P1-PN in the same performance event (a mirror performance of the performance event of P1-PN). For TTPs located in geographic regions in which gambling is legal, the TTPs associated with the Performers P1-PN may bet (or gamble) against each other, as the mirror performance proceeds. In this manner, TTPs located in geographic regions in which gambling is legal may place bets on the outcome of the performance, even if the Performers P1-PN are located in geographic regions in which gambling is not legal.

Also, in particular embodiments, the Performers P1-PN do not gamble with real money during a performance. Instead, the Performer's P1-PN may play with virtual money (for example, tokens or virtual money assigned to the performers by the SPE (e.g., as part of the Registration process or thereafter). In such embodiments, the Performers P1-PN are not paid during or after the performance, based on the amount of tokens or virtual money collected during the performance. However, the Performers P1-PN may be paid for sales of performance rights as described above.

In certain embodiments, a Performer P1-PN may not desire to offer or sell performance rights, yet may still desire to perform in the event. In FIG. 3, the N branch from Query 108 represents a situation in which the Performer P1 has responded to the Query 108 with a response indicating that the P1 does not desire to offer or sell performance rights. The N branch from Query 108 proceeds to the first (or next) stage or round of the performance event.

Various manners of implementing a process as described above may be accomplished within the scope of the present invention. For example, in one embodiment, Registering 102 a Performer 14 (such as P1) for a performance event with the SPE 18 involves a website registration process. For example, to register, the Performer 14 accesses a website operated by or for the SPE 18 to register. The website provides a registration interface, including a mechanism for the Performer 14 to enter (and the SPE 18 to receive) personal information, payment information, account or address information for receiving compensation, or other information associated with the Performer. In particular embodiments, the Performer 14 may pre-register with the SPE 18 (where the SPE 18 records personal, payment, account, address and/or other information and associates that information with a user code), such that registration for a performance event (e.g., game, sport, etc.) may be simplified by allowing the Performer 14 to enter the pre-assigned user code, without requiring entry of the pre-recorded information noted above. In particular embodiments, payment information may be provided by the Performer 14 to the SPE 18, through a TPPS 20 (such as, but not limited to PayPal or the like).

For certain types of performance events, such as gambling style games, a Performer 14 is issued a predefined sum for betting (such as, but not limited to, a predefined number of gambling tokens or predefined betting value) from which one or more bets can be made by the Performer 14 during the performance event. In further embodiments, a registration (or other) fee is paid by the Performer 14, for receiving the predefined sum for betting. In yet further embodiments, the Performer 14 has the option to pay additional registration (or other) fees for obtaining additional sums for betting (such as, but not limited to additional gambling tokens or an additional betting value). In certain embodiments, the Performer may select from a plurality of predefined fees, each associated with a different predefined sum for betting.

In other embodiments, Registration 102 may be carried out in other suitable manners, for example, but not limited to, the performer visiting a physical location to complete a registration form, mailing registration information to the SPE 18 via postal or other hand delivery manners, submitting registration information via email or other suitable electronic delivery mechanism.

As part of Registration 102 (or before or after Registration 102), the Performer P1 (or P1-PN) provides selection information to the SPE 18 (and the SPE 18 receives such selection information from the Performer P1 or P1-PN). Such selection information is provided via input and output devices and interfaces, as described above. In one example embodiment the SPE 18 provides a website on which a Performer P1-PN may receive audio, visual or tactile information and may communicate to the SPE audio, visual or tactile information.

In particular embodiments, the interface is also configured to allow the Performer 14 to enter (via one or more input devices as described above) selection information, such as the selection of a game, sport, or other performance environment in which the Performer 14 desires to participate, and/or the selection of one or more other Performers 14 to participate together in a common performance (such as opponents in a game or sport), and/or the selection of a sum for betting (such as, but not limited to, a selection of a number of gambling tokens or a gambling value and associated fees). In one embodiment, the Performer P1 registers and selects an event, such as a game or sport to play. In particular embodiments, the Performer is charged a fee by the SPE 18 for the ability to perform (e.g., perform in an online game, sport or other online performance event).

As discussed above, the Performer P1 is matched with one or more additional Performers P2 . . . PN. The matching may be accomplished by the Performer P1 entering (and the SPE 18 receiving) selection information for selecting an opponent (such as a friend, colleague or on-line acquaintance) to play against, as an opponent in the game. Depending on the type of game, more than one opponent may be selected. Alternatively or in addition, the game may involve teams of multiple players, such that the Performer P1 may select one or more team members. In other embodiments, opponents and/or team members are assigned by the SPE 18, with or without input from the Performer P1 (or other performers in the event). In certain embodiments, Performers P2 PN matched with P1 may be other user Performers that have registered with the SPE 18 for the same performance event (game or sport) as the Performer P1, at or around the same time (or are awaiting to register or be matched at or around the same time) that Performer P1 registers or starts a performance. In other embodiments, other Performers that the Performer P1 is matched with (as opponent(s) and/or teammate(s)) are computers operated by employees, associates or agents of the SPE 18. In yet further embodiments, other performers that the Performer P1 is matched with (as opponent(s) and/or teammate(s)) are electronically generated (or virtual) Performers, generated by, for example, the SPE 18.

Matching of a Performer P1 with one or more other Performers P2-PN may be carried out by a computerized program run by the SPE 18. The SPE 18 may employ one or more of criteria in determining matches, including, but not limited to, performers skill level, experience, age, knowledge, gender, geographic location, or the like. For example, the SPE 18 may be configured to match performers having similar skill levels, so that a performance can be relatively balanced. The SPE 18 may maintain an electronic record (for example, in a database 22) of performance records or other data associated with Performers P1-PN, to define or determine matching criteria, as described above. In further embodiments, a Performer P1 may provide the SPE 18 with matching preferences (for example, a selection of another performer that P1 would like to perform with or against in the performance event).

Once a performance event (such as a game or sport) and Performers are registered and/or matched with opponents or teammate Performers, a performance event (such as a game or sport) may begin.

However, as described above, in certain embodiments, the Performer P₁ is provided the opportunity to sell, license or otherwise provide performance rights in the Performer's (P₁'s) performance in the event. The performance rights may include one or more of rights to view, record, replay, copy, modify, distribute or conduct other actions relating to the Performer's (P₁'s) performance in the event. In further embodiments, the Performer P₂ (and/or other Performers P_{N}) may be provided the opportunity to sell, license or otherwise provide similar performance rights in that Performer's (P₂'s or P_{N}'s) performance in the event.

In an example embodiment, the Performer P1 (or Performers P1-PN) that desire to sell, license or otherwise provide their performance rights for a fee, are paid by the SPE to perform in the performance event. A performance right price value (PRPV) is calculated and associated with the performer P1 (or with each performer P1-PN for which a PRPV is calculated).

The PRPV for a performer may be a set fee available to all performers, for example, set by the SPE. In further embodiments different fees are set for different groups of performers. For example a first fee amount may be set for performers that meet certain pre-defined criteria, a second fee amount may be set for performers that meet other pre-defined criteria, etc. Such criteria may include, but is not limited to level of experience, level of professional experience, skill, knowledge, age, gender, geographic location, etc. Thus, performers with a predefined level of professional backgrounds (predefined number of years of experience or of professional/paid experience, predefined handicaps, national rankings, etc.) may be categorized in one group, while performers with non-professional experience may be categorized in another group, and performers with little or no experience may be categorized in yet another group.

In particular embodiments, where the performance event is a game or a sport, a PRPV for Performer P1 (or for each Performer P1-PN) is based, at least in part, on the likelihood of success or the odds of that Performer winning of a game. Thus, performers with better chances of winning may have, for example, a higher (or a lower) PRPV, as compared to performers with a less likely chance of winning. Such chances of winning (or odds) for a given performer (or each performer in a performance event) may be calculated at various points of time relative to the performance event. For example, such chances or odds may be calculated at the beginning of the performance event (or before the event begins). Alternatively, or in addition, such chances or odds may be calculated at pre-set stages (such as at each or certain designated rounds or stages of play of a game or other event). Such stages or rounds may be selected, based on the type of game or other event being played as the performance event. For example, games such as poker have traditional rounds or periods of betting (at each deal or at each draw) where a performer's chances of winning (or odds) can be calculated and may have changed from a previous round or period in the game. Other games, such as computer video, sports or arcade games are or can be configured with defined rounds or periods at which a performer's chances of winning (or odds) can be calculated. In particular embodiments, the SPE 18 calculates each performer's chances of winning (or odds), at least at the designated rounds or periods, where such calculation is employed in the calculation of the performer's PRPV.

Each performer's PRPV (or associated value) is provided to the performer for display to that performer. In this manner, the performer may consider his or her PRPV when deciding whether or not to respond with a positive or a negative response to the Query 108. In some embodiments, each performer's PRPV (or associated value) is made available to all other performers in the same performance event. However, in further embodiments, each performer is provided access only to his or her own PRPV (at least during the performance of the event), so that the performer is not able to observe changes in an opponents PRPV that may indicate, for example, that the opponent has just drawn a good card or has obtained some advantageous position in the performance.

If a performer desires to offer, license or sell performance rights in his or her performance, then the SPE may issue a payment to the performer, based, for example, on the performer's PRPV. A payment may be made to the performer at the beginning of a performance event and/or at one or more defined rounds or stages of the performance event, and/or at the end of the performance event. The SPE may calculate, such as by maintaining a running total or other calculation mechanism, of the payment due to a performer. The performer may accumulate payments, in the form of recorded amounts, points, credits or the like, as maintained by the SPE. The SPE pays the performer, for example, by sending a check, crediting a bank account or providing other financially negotiable instrument to the performer, for example, after completion of a performance event (or after completion of a set number of performance events). Alternatively, or in addition, the payment to the performer may be made in the form of credits (for example, to apply for fees to participate in additional performances, or to apply to other games or events offered by the SPE or other entities).

In one embodiment, performers are paid in credits (as noted above), until and unless one (or a predefined number) of TPPS are associated with the performer. However, once a predefined number of TPPs are associated with a performer, then the performer may be paid for the performance rights with a monetary form of payment (either in addition to or as an alternative to credits as noted above). In this manner, the SPE 18 may collect fees from TPPs and use part or all of those fees to cover costs of paying for performance rights to the Performer P1. However, until a suitable number (1-N) of paying TPPs is associated with the Performer P1, then the SPE 18 compensates the Performer P1 with credits, instead of monetary payments.

The TPPs may register to play in a similar manner as described above for Registration 102 of Performers Pl-PN. However, TPPs register as Third Party Players and receive a mirror (copy) of the performance being played by the associated Performer P1-PN. Thus, the TPPs participation in the mirror (or copy) of the performance event may be to simply mirror (or copy) the performance of the associated Performer P1-PN in the performance event. In this manner, a TPP can simulate a performance of one of the Performers P1-PN. Thus, for example, the TPP can play the same game strategy (the same plays, hands, etc.) as played by one of the Performers P1-PN. The TPP can, thus, mirror or copy the play of a very experienced or professional Performer P1-PN.

In certain embodiments, multiple TPPs can play against each other by mirroring or copying the plays of associated Performers P1-PN, and play the same game (or make the same performance) as a highly experienced or professional Performer Pl-PN. Furthermore, TPPs may be able to gamble and bet against each other (or against a house or other entity) on the outcome of their performances (mirroring or copying performances of Performers P1-PN), even if the Performer's P1-PN are not located in a geographic region that allows gambling. In particular embodiments, the SPE matches TPPs for performances, and maintains records to allow the TPPs to record bets and make and receive payments (via the SPE), to cover bets and collect winnings.

In further embodiments, TPPs are provided with the ability to alter or adjust their performance in the mirrored or copied performance event, relative to the performance of their associated Performer in the performance event. In such embodiments, the TPP need not make plays or moves that match the play or move of the associated Performer P1-PN.

In particular embodiments, the TPPs pay a fee to the SPE 18 to participate. The fee may be a set fee that is the same for all TPPs participating in the same performance event. Alternatively, different fees may be charged to different TPPs. In a particular embodiment, the fee charged to a TPP is based, in part, on the calculated PRPV of the associated Performer P1-PN. Thus, a TPP may be charged a higher fee to participate, if the TPP is associated with a Performer with a higher PRPV, relative the fee charged to another TPP associated with a Performer having a lower PRPV. In this regard, TPPs may be charged higher fees to have the opportunity to mirror or copy the plays or moves of a Performer with a relatively high PRPV (e.g., a Performer with a relatively high level of skill, experience or other criteria that increases PRPV), as compared to fees charged to mirror or copy a Performer with a relatively low PRPV.

Accordingly, in systems and processes as described above, the SPE 18 collects fees from Performers P1-PN and/or from TPPs to participate in performances. In addition, the SPE 18 may assist in management of bets carried out between TPPs and, in some embodiments, obtains a fee based on a percentage of those bets or for handling those bets. The SPE 18 may pay out performance right fees to Performers P1-PN. The SPE 18 may configure the fee collection and payment arrangements such that payments to Performers P1-PN will be sufficiently lower (or a defined percentage of) the overall fees paid to the SPE 18, such that the SPE 18 may generate revenue for running the service.

The embodiments disclosed herein are to be considered in all respects as illustrative and not restrictive of the invention. The scope of the invention is indicated by the appended claims, rather than the foregoing description. All changes that come within the meaning and range of equivalency of the claims are therefore intended to be embraced therein.

What is claimed is:

1. A system for providing performance content on a communication network, comprising a computer coupled to the communication network for communicating over the communication network with a plurality of online users, including at least one first on-line user and at least one second on-line user, the computer configured for:
providing a first performance environment over the communication network to at least one first on-line user, in which the first on-line user is able to make a performance;
receiving performance data from the at least one first on-line user corresponding to the first on-line user's performance in the first performance environment;
defining a value for one or more performance rights associated with the received data corresponding to the first on-line user's performance in the first performance environment;
providing a second performance environment over the communication network to at least one second on-line user, in which the second on-line user is able to make a performance, the second performance environment being a separate performance environment relative to the first performance environment;
providing the at least one second on-line user with access to received data corresponding to the first on-line user's performance in the first performance environment, while the second on-line user is making a performance in the second performance environment.

2. A system as recited in claim 1, wherein the second performance environment is a copy or mirror of the first performance environment.

3. A system as recited in claim 1, wherein the first performance environment comprises a video game.

4. A system as recited in claim 1, wherein the first performance environment comprises an on-line gambling game in which each first on-line user makes wagers or bets during one or more stages of the gambling game.

5. A system as recited in claim 4, wherein the second performance environment comprises an on-line gambling game in which each second on-line user makes wagers or bets during one or more stages of the gambling game.

6. A system as recited in claim 1, wherein the second performance environment comprises an on-line gambling game in which each second on-line user makes wagers or bets during one or more stages of the gambling game.

7. A system as recited in claim 1, wherein the first performance environment comprises at least one on-line game including poker, blackjack, pai gow, baccarat, bridge, craps, ma Jong, dominos, chess, or backgammon.

8. A system as recited in claim 1, further comprising receiving performance data from the at least one second on-line user corresponding to the second on-line user's performance in the first performance environment.

9. A system as recited in claim 8, further comprising defining a value for one or more performance rights associated with the received data corresponding to the second on-line user's performance in the second performance environment.

10. A system as recited in claim 9, further comprising:
receiving a payment from at least one of each first user and each second user;
providing a payment to at least one of a first user and a second user, for performance rights associated with the user's performance in the first or second performance environment.

11. A process for operating a computer to electronically communicate performance content on a communication network with a plurality of online users, including at least one first on-line user and at least one second on-line user, the process comprising:
providing a first performance environment over the communication network to at least one first on-line user, in which the first on-line user is able to make a performance;
receiving performance data from the at least one first on-line user corresponding to the first on-line user's performance in the first performance environment;
defining a value for one or more performance rights associated with the received data corresponding to the first on-line user's performance in the first performance environment;
providing a second performance environment over the communication network to at least one second on-line user, in which the second on-line user is able to make a performance, the second performance environment being a separate performance environment relative to the first performance environment;
providing the at least one second on-line user with access to received data corresponding to the first on-line user's performance in the first performance environment, while the second on-line user is making a performance in the second performance environment.

12. A process as recited in claim 11, wherein the second performance environment is a copy or mirror of the first performance environment.

13. A process as recited in claim 11, wherein the first performance environment comprises a video game.

14. A process as recited in claim 12, wherein the first performance environment comprises an on-line gambling game in which each first on-line user makes wagers or bets during one or more stages of the gambling game.

15. A process as recited in claim 14, wherein the second performance environment comprises an on-line gambling game in which each second on-line user makes wagers or bets during one or more stages of the gambling game.

16. A process as recited in claim 11, wherein the second performance environment comprises an on-line gambling game in which each second on-line user makes wagers or bets during one or more stages of the gambling game.

17. A process as recited in claim 11, wherein the first performance environment comprises at least one on-line game including poker, blackjack, pai gow, baccarat, bridge, craps, ma Jong, dominos, chess, or backgammon.

18. A process as recited in claim 11, further comprising receiving performance data from the at least one second on-line user corresponding to the second on-line user's performance in the first performance environment.

19. A process as recited in claim 18, further comprising defining a value for one or more performance rights associated with the received data corresponding to the second on-line user's performance in the second performance environment.

20. A process as recited in claim 19, further comprising:
receiving a payment from at least one of each first user and each second user;
providing a payment to at least one of a first user and a second user, for performance rights associated with the user's performance in the first or second performance environment.
